(19) United States
(12) Patent Application Publication
(10) Pub. No.: US 2014/0027626 A1
(43) Pub. Date: Jan. 30, 2014

(54) OPTICAL PHOTODETECTOR FOR HIGH TEMPERATURE OPERATION

(71) Applicant: Sebastian Csutak, Houston, TX (US)

(72) Inventor: Sebastian Csutak, Houston, TX (US)

(73) Assignee: BAKER HUGHES INCORPORATED, Houston, TX (US)

(21) Appl. No.: 13/556,935

(22) Filed: Jul. 24, 2012

(51) Int. Cl. G01V 8/10

(52) U.S. Cl. 250/256

(57) ABSTRACT

An apparatus configured for estimating a parameter of interest in a borehole using at least one photodiode configured to generate signals, the at least one photodiode including a substance configured to reduce current leakage of the at least one photodiode in a downhole temperature environment. The method may include using the apparatus under downhole conditions.

### FIELD OF THE DISCLOSURE

This disclosure generally relates to the production of hydrocarbons from an earth formation. More specifically, this disclosure relates to estimating at least one parameter of interest downhole using a photodiode detector.

### BACKGROUND OF THE DISCLOSURE

Oil and gas wells have been drilled at depths ranging from a few thousand feet to as deep as 5 miles. Wireline and drilling tools often incorporate various sensors, instruments and control devices in order to carry out any number of downhole operations. These operations may include formation testing, fluid analysis, and tool monitoring and control.

The environment in these wells present many challenges to maintain the tools used at depth due to vibration, harsh chemicals, and temperature. Temperature in downhole tool applications presents a unique problem to these tools. High downhole temperatures may reach as high as 200 degrees C. or more, and sensitive electronic equipment must be cooled in order to work in the environment. An added problem is that space in the carrier assembly is usually limited to a few inches in diameter. Cooling systems take up valuable space in the tool carrier and add an additional failure point in the system. Sensors may be limited in operation at high temperatures and suffer from low signal to noise ratios due to current leakage. This disclosure provides for an apparatus and method for performing measurements in a high temperature environment.

### SUMMARY OF THE DISCLOSURE

In aspects, this disclosure generally relates to the production of hydrocarbons involving analysis of fluids in or from an earth formation. More specifically, this disclosure relates to estimating the environmental conditions for precipitate to form in a hydrocarbon fluid.

One embodiment according to the present disclosure includes a method for downhole operations, the method comprising: generating a signal indicative of at least one parameter of interest using at least one photodiode, wherein the at least one photodiode includes a substance configured to reduce current leakage of the at least one photodiode in a downhole temperature environment.

Another embodiment according to the present disclosure includes an apparatus configured to operate downhole, the apparatus comprising: at least one photodiode configured to generate a signal downhole indicative of at least one parameter of interest, the at least one photodiode comprising a substance selected to reduce current leakage of the at least one photodiode in a downhole temperature environment.

Examples of the more important features of the disclosure have been summarized rather broadly in order that the detailed description thereof that follows may be better understood and in order that the contributions they represent to the art may be appreciated.

### BRIEF DESCRIPTION OF THE DRAWINGS

For a detailed understanding of the present disclosure, reference should be made to the following detailed description of the embodiments, taken in conjunction with the accompanying drawings, in which like elements have been given like numerals, wherein:

FIG. 1 shows a schematic of a photodiode deployed in a wellbore on a bottomhole assembly according to one embodiment of the present disclosure;

FIG. 2 shows a schematic of an exemplary photodiode according to one embodiment of the present disclosure;

FIG. 3 shows a flow chart of an exemplary method for estimating a parameter of interest in a borehole using a photodiode at downhole temperatures according to one embodiment of the present disclosure; and

FIG. 4 shows a chart of curves for photodiodes with and without an added substance to increase binding of valence electrons to the lattice according to one embodiment of the present disclosure.

### DETAILED DESCRIPTION

This disclosure generally relates to the production of hydrocarbons from an earth formation. More specifically, this disclosure relates to estimating at least one parameter of interest downhole using a photodiode detector.

The present disclosure uses terms, the meaning of which terms will aid in providing an understanding of the discussion herein. As used herein, high temperature refers to a range of temperatures typically experienced in oil production well boreholes. For the purposes of the present disclosure, downhole temperature includes a range of temperatures from about 100 degrees C. to about 220 degrees C. (about 212 degrees F. to about 428 degrees F.).

Typically, semiconductor devices are sensitive to temperature. The band gap of a semiconductor may be reduced by increases in temperature. The band gap is the amount of energy required to cause an electron to jump from the valence band into the conduction band. As temperature increases, the energy in electrons in the semiconductor may increase, making it easier for bonds with valence electrons to the semiconductor lattice to be broken. Increasing the strength of these bonds may increase the band gap of the semiconductor, thus enabling operation at higher temperatures and increasing the signal-to-noise ratio at any given temperature. The addition of certain substances, such as phosphorus, to the semiconductor material may increase the strength of binding of valence electrons to the lattice. Parameters of interest may be measured using devices including a photo-responsive semiconductor, such as a photodiode, with an increased band gap as discussed in the embodiments below.

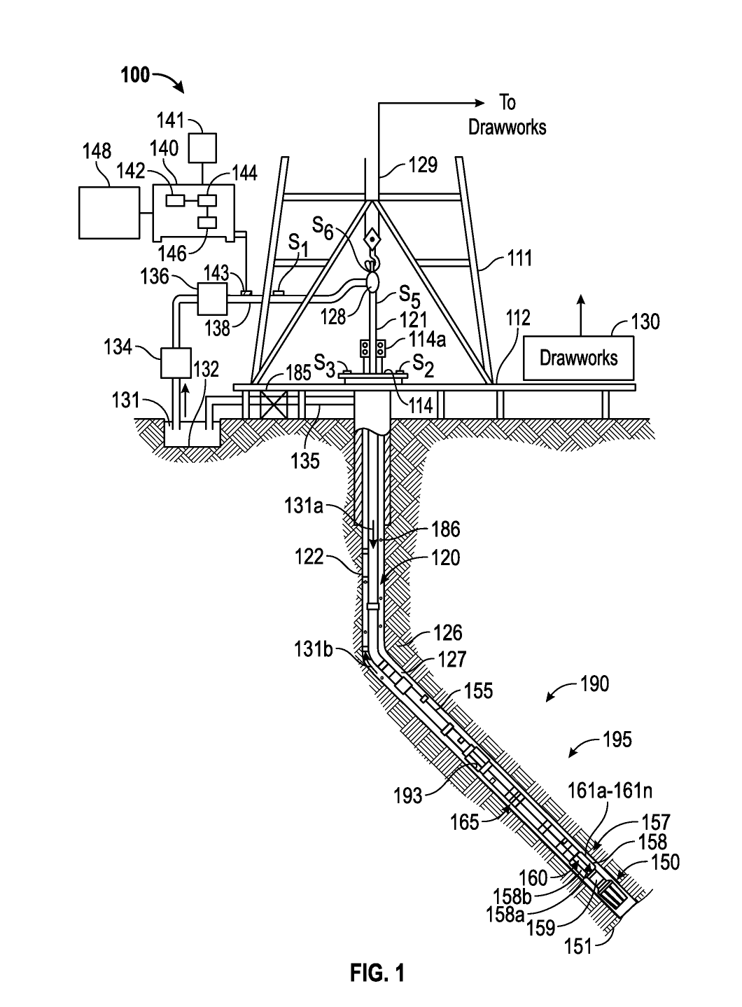

FIG. 1 is a schematic diagram of an exemplary drilling system 100 that includes a drill string having a drilling assembly attached to its bottom end that includes a steering unit according to one embodiment of the disclosure. FIG. 1 shows a drill string 120 that includes a drilling assembly or bottomhole assembly (BHA) 190 conveyed in a borehole 126. The drilling system 100 includes a conventional derrick 111 erected on a platform or floor 112 which supports a rotary table 114 that is rotated by a prime mover, such as an electric motor (not shown), at a desired rotational speed. A tubing (such as jointed drill pipe 122), having the drilling assembly 190, attached at its bottom end extends from the surface to the bottom 151 of the borehole 126. A drill bit 150, attached to drilling assembly 190, disintegrates the geological formations when it is rotated to drill the borehole 126. The drill string 120 is coupled to a drawworks 130 via a Kelly joint 121, swivel 128 and line 129 through a pulley. Drawworks 130 is operated to control the weight on bit (“WOB”). The drill string 120 may be rotated by a top drive (not shown) instead of by the prime mover and the rotary table 114. Alternatively, a coiled-tubing may be used as the tubing 122. A tubing injector 114a may be used to convey the coiled-tubing having the drilling assembly attached to its bottom end. The operations of the drawworks 130 and the tubing injector 114a are known in the art and are thus not described in detail herein.

A suitable drilling fluid 131 (also referred to as the “mud”) from a source 132 thereof, such as a mud pit, is circulated under pressure through the drill string 120 by a mud pump 134. The drilling fluid 131 passes from the mud pump 134 into the drill string 120 via a desurger 136 and the fluid line 138. The drilling fluid 131a from the drilling tubular discharges at the borehole bottom 151 through openings in the drill bit 150. The returning drilling fluid 131b circulates uphole through the annular space 127 between the drill string 120 and the borehole 126 and returns to the mud pit 132 via a return line 135 and drill cutting screen 185 that removes the drill cuttings 186 from the returning drilling fluid 131b. A sensor S₁ in line 138 provides information about the fluid flow rate. A surface torque sensor S₂ and a sensor S₃ associated with the drill string 120 respectively provide information about the torque and the rotational speed of the drill string 120. Tubing injection speed is determined from the sensor S₅, while the sensor S₆ provides the hook load of the drill string 120.

In some applications, the drill bit 150 is rotated by only rotating the drill pipe 122. However, in many other applications, a downhole motor 155 (mud motor) disposed in the drilling assembly 190 also rotates the drill bit 150. The rate of penetration (ROP) for a given BHA largely depends on the WOB or the thrust force on the drill bit 150 and its rotational speed.

The mud motor 155 is coupled to the drill bit 150 via a drive shaft disposed in a bearing assembly 157. The mud motor 155 rotates the drill bit 150 when the drilling fluid 131 passes through the mud motor 155 under pressure. The bearing assembly 157, in one aspect, supports the radial and axial forces of the drill bit 150, the down-thrust of the mud motor 155 and the reactive upward loading from the applied weight-on-bit.

A surface control unit or controller 140 receives signals from the downhole sensors and devices via a sensor 143 placed in the fluid line 138 and signals from sensors S₁-S₆ and other sensors used in the system 100 and processes such signals according to programmed instructions provided to the surface control unit 140. The surface control unit 140 displays desired drilling parameters and other information on a display/monitor 141 that is utilized by an operator to control the drilling operations. The surface control unit 140 may be a computer-based unit that may include a processor 142 (such as a microprocessor), a storage device 144, such as a solid-state memory, tape or hard disc, and one or more computer programs 146 in the storage device 144 that are accessible to the processor 142 for executing instructions contained in such programs. The surface control unit 140 may further communicate with a remote control unit 148. The surface control unit 140 may process data relating to the drilling operations, data from the sensors and devices on the surface, data received from downhole, and may control one or more operations of the downhole and surface devices. The data may be transmitted in analog or digital form.

The BHA 190 may also contain formation evaluation sensors or devices (also referred to as measurement-while-drilling (“MWD”) or logging-while-drilling (“LWD”) sensors) determining resistivity, density, porosity, permeability, acoustic properties, nuclear-magnetic resonance properties, formation pressures, properties or characteristics of the fluids downhole and other desired properties of the formation 195 surrounding the BHA 190. Such sensors are generally known in the art and for convenience are generally denoted herein by numeral 165. The BHA 190 may further include a variety of other sensors and devices 159 for determining one or more properties of the BHA 190 (such as vibration, bending moment, acceleration, oscillations, whirl, stick-slip, etc.) and drilling operating parameters, such as weight-on-bit, fluid flow rate, pressure, temperature, rate of penetration, azimuth, tool face, drill bit rotation, etc.) For convenience, all such sensors are denoted by numeral 159.

The BHA 190 may include a steering apparatus or tool 158 for steering the drill bit 150 along a desired drilling path. In one aspect, the steering apparatus may include a steering unit 160, having a number of force application members 161a-161n, wherein the steering unit is at partially integrated into the drilling motor. In another embodiment the steering apparatus may include a steering unit 158 having a bent sub and a first steering device 158a to orient the bent sub in the wellbore and the second steering device 158b to maintain the bent sub along a selected drilling direction.

The drilling system 100 may include sensors, circuitry and processing software and algorithms for providing information about desired dynamic drilling parameters relating to the BHA, drill string, the drill bit and downhole equipment such as a drilling motor, steering unit, thrusters, etc. Exemplary sensors include, but are not limited to drill bit sensors, an RPM sensor, a weight on bit sensor, sensors for measuring mud motor parameters (e.g., mud motor stator temperature, differential pressure across a mud motor, and fluid flow rate through a mud motor), and sensors for measuring acceleration, vibration, whirl, radial displacement, stick-slip, torque, shock, vibration, strain, stress, bending moment, bit bounce, axial thrust, friction, backward rotation, BHA buckling, and radial thrust. Sensors distributed along the drill string can measure physical quantities such as drill string acceleration and strain, internal pressures in the drill string bore, external pressure in the annulus, vibration, temperature, electrical and magnetic field intensities inside the drill string, bore of the drill string, etc. Suitable systems for making dynamic downhole measurements include COPILOT, a downhole measurement system, manufactured by BAKER HUGHES INCORPORATED. Suitable systems are also discussed in “Downhole Diagnosis of Drilling Dynamics Data Provides New Level Drilling Process Control to Driller”, SPE 49206, by G. Heisig and J. D. Macpherson, 1998.

The drilling system 100 can include one or more downhole processors at a suitable location such as 193 on the BHA 190. The processor(s) can be a microprocessor that uses a computer program implemented on a suitable non-transitory computer-readable medium that enables the processor to perform the control and processing. The non-transitory computer-readable medium may include one or more ROMs, EPROMs, EAROMs, EEPROMs, Flash Memories, RAMs, Hard Drives and/or Optical disks. Other equipment such as power and data buses, power supplies, and the like will be apparent to one skilled in the art. In one embodiment, the MWD system utilizes mud pulse telemetry to communicate data from a downhole location to the surface while drilling operations take place. The surface processor 142 can process the surface measured data, along with the data transmitted from the downhole processor, to evaluate formation lithology. While a drill string 120 is shown as a conveyance system for sensors 165, it should be understood that embodiments of the present disclosure may be used in connection with tools conveyed via rigid (e.g. jointed tubular or coiled tubing) as well as non-rigid (e. g. wireline, slickline, e-line, etc.) conveyance systems. The drilling system 100 may include a bottomhole assembly and/or sensors and equipment for implementation of embodiments of the present disclosure on either a drill string or a wireline.

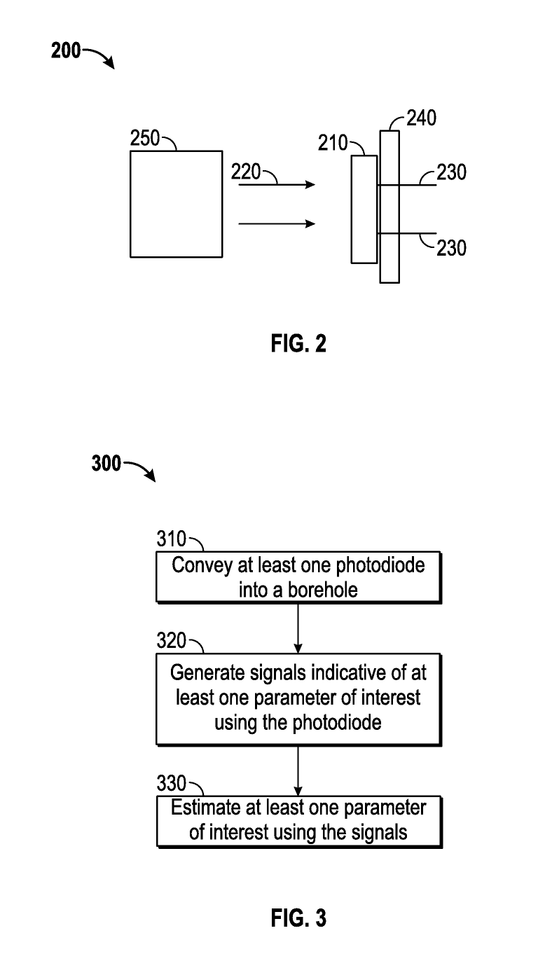

FIG. 2 shows a detector, such as photodiode 200, that may be incorporated in BHA 190, such as along with evaluation sensors 165 according to one embodiment of the present disclosure. The detector 200 may include one or more photodiode semiconductor structures 210 configured to be responsive to electromagnetic radiation. In some embodiments, the semiconductor structure may include a crystal comprising semiconductor material. When photons 220 interact with the semiconductor structure 210, an electrical signal may be generated and communicated through electrical conductors 230. In some embodiments, photons 220 may have a wavelength shorter than about 1350 nanometers. An optional cooling device 240 may be included to reduce the temperature of the semiconductor structure 210. The detector 200 may be disposed in or on BHA 190. In some embodiments, an electromagnetic radiation source 250 (optional) may be configured to transmit electromagnetic radiation to the detector 200.

Detector 200 may be used alone or incorporated into a more complicated measurement device (i.e. gravimeter, interferometer, etc.) that may used in downhole operations and/or measurement as would be understood by one of skill in the art. Detector 200 may also be configured to act a signal receiver, as in a communications tool. The generated signal may be indicative of at least one parameter of interest. The at least one parameter of interest may include, but is not limited to, one or more of: (i) gravitational acceleration, (ii) temperature, (iii) magnitude of electromagnetic radiation, iv) frequency of electromagnetic radiation, v) strain, vi) acceleration, vii) vibration, viii) flow rate, and (ix) pressure.

Semiconductor structure 210 may be configured to convert electromagnetic radiation into an electrical signal. An exemplary embodiment of semiconductor structure 210 includes indium, gallium, arsenic, and phosphorus. Semiconductor structure 210 may include a ternary material, such as In_{0.53}Ga_{0.47}As, and a substance configured to increase binding of valence electrons to a lattice of the ternary material. In some embodiments, the substance includes phosphorus. In some embodiments, semiconductor structure 210 consists essentially of indium, gallium, arsenic and phosphorus. In some embodiments, the semiconductor structure 210 may have a chemical formula of the form In₍₁₋ₓ₎GaₓAs_{y}P_{(1-y)}, where x and y have values in a range of 0 to 1. The values of x and y may be selected to maintain a lattice-match in the semiconductor structure. The values of x and y may also be selected so that that semiconductor structure is sensitive to photons at wavelengths below 1700 nanometers. The values of x and y may be selected so that the semiconductor structure in sensitive to photons at wavelengths of about 1350 nanometers and smaller. The use of ternary material is illustrative and exemplary only, as other materials may be combined with a substance configured to increase binding of valence electrons to their lattice, such as InGa.

Typically, photosensitive devices may have a small electric current when there are no photons being received by the device. This “dark current” leakage (also known as bias leakage current) may generate noise that impairs the signal generated by the device. The leakage current may be proportional to a carrier concentration, nᵢ, as expressed in the formula:

$${n}_{i}^{2} = 4 {( \frac{2 π k T}{{h}^{2}} )}^{3} {( {m}_{e}^{*} {m}_{h}^{*} )}^{3 / 2} exp ( - \frac{{E}_{G 0}}{kT} ) ,$$

where T is temperature in Kelvin; h is Planck's constant; k is Boltzmann's constant; mₑ and mₕ are effective masses of electrons and holes; and E_{G0} is the band gap linearly extrapolated to absolute zero. The increase in band gap due to the increase in binding of the valence electrons to the lattice is related to the increase in E_{G0}, such that an increase in E_{G0} will result in a smaller value of nᵢ.

The increase of binding of the valence electrons to the lattice of the material may reduce current leakage of the detector 200. The increase of binding of the valence electrons to the lattice of the material may increase the functional operating temperature of the detector 200. The increase of binding of the valence electrons to the lattice of the material may increase the signal-to-noise ratio of detector 200 at downhole temperatures. The increase of binding of the valence electrons to the lattice of the material may increase band gap of the detector 200.

FIG. 3 shows a flow chart 300 for estimating at least one parameter of interest downhole according to one embodiment of the present disclosure. In step 310, detector 200, including at photodiode semiconductor structure 210, may be conveyed in a borehole 126. In step 320, signals are generated by the photodiode semiconductor structure 210 in response to photons 220 interacting with the photodiode semiconductor structure 210. The signals may be generated at downhole temperatures. In some embodiments, the downhole temperatures may exceed 200 degrees C. The signals may be indicative of at least one parameter of interest. In step 330, the at least one parameter of interest may be estimated using the signals. In some embodiments, an electromagnetic source 250 may generate photons 220. The at least one parameter of interest may include, but is not limited to, one or more of: (i) gravitational acceleration, (ii) temperature, (iii) magnitude of electromagnetic radiation, iv) frequency of electromagnetic radiation, v) strain, vi) acceleration, vii) vibration, viii) flow rate, and (ix) pressure.

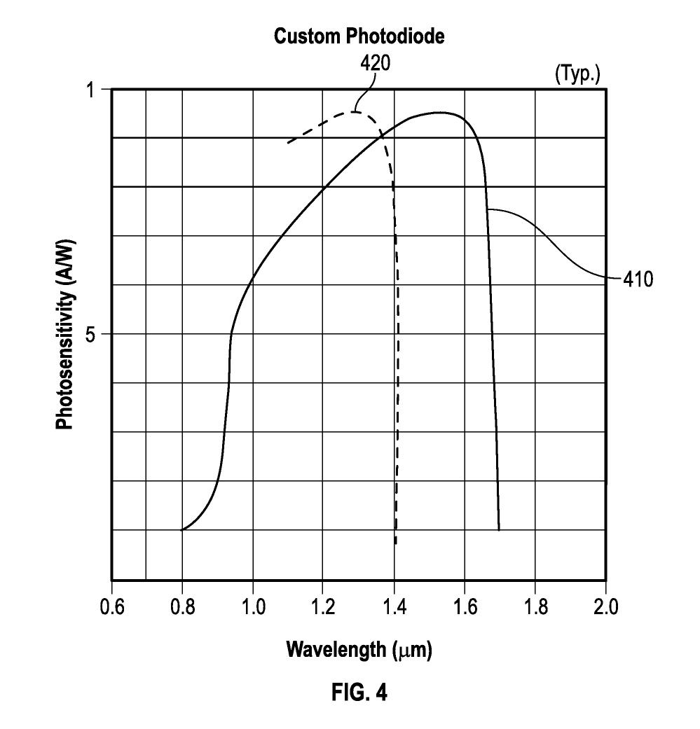

FIG. 4 shows a set of curves indicating the photosensitivity of photodiodes as related to wavelength at downhole temperatures. Curve 410 shows the photosensitivity of a photodiode using In_{0.53}Ga_{0.47}As, which appears to have a wavelength that approaches 1.7 micrometers as temperature increases. Curve 420 shows the photosensitivity of a photodiode using indium gallium arsenide with phosphorus added. Curve 420 is noticeably shifted to the left (lower wavelength) due to the addition of the phosphorus. The relative amounts of indium, gallium, arsenic, and phosphorus may be selected to maintain the integrity of the semiconductor structure lattice (e.g. maintain lattice-match). In some embodiments, curve 420 may be shifted to a wavelength of about 1.350 micrometers.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Such insubstantial variations are to be considered within the scope of the claims below.

Given the above disclosure of general concepts and specific embodiments, the scope of protection is defined by the claims appended hereto. The issued claims are not to be taken as limiting Applicant's right to claim disclosed, but not yet literally claimed subject matter by way of one or more further applications including those filed pursuant to the laws of the United States and/or international treaty.

We claim:

1. A method for downhole operations, the method comprising:
generating a signal indicative of at least one parameter of interest using at least one photodiode, wherein the at least one photodiode includes a substance configured to reduce current leakage of the at least one photodiode in a downhole temperature environment.

2. The method of claim 1, wherein the at least one photodiode includes a ternary material and the substance is selected to increase binding of valence electrons to a lattice of the ternary material.

3. The method claim 2, wherein the ternary material comprises indium, gallium, and arsenic.

4. The method of claim 1, wherein the substance comprises phosphorus.

5. The method of claim 1, wherein the downhole temperature environment is at least about 200 degrees Celsius.

6. The method of claim 1, wherein the at least one parameter includes at least one of: (i) gravitational acceleration, (ii) temperature, (iii) magnitude of electromagnetic radiation, iv) frequency of electromagnetic radiation, v) strain, vi) acceleration, vii) vibration, viii) flow rate, and (ix) pressure.

7. The method of claim 1, wherein the at least one photodiode is configured to be responsive to electromagnetic radiation having a wavelength shorter than about 1350 nanometers.

8. The method of claim 1, further comprising:
conveying the at least one photodiode on a carrier in a borehole.

9. An apparatus configured to operate downhole, the apparatus comprising:
at least one photodiode configured to generate a signal downhole indicative of at least one parameter of interest, the at least one photodiode comprising a substance selected to reduce current leakage of the at least one photodiode in a downhole temperature environment.

10. The apparatus of claim 9, wherein the at least one photodiode includes a ternary material and the substance is selected increase the electron density of the ternary material.

11. The apparatus of claim 10, wherein the ternary material comprises indium, gallium, and arsenic.

12. The apparatus of claim 9, wherein the substance comprises phosphorus.

13. The apparatus of claim 9, wherein the downhole temperature environment is at least about 200 degrees Celsius.

14. The apparatus of claim 9, wherein the at least one parameter includes at least one of: (i) gravitational acceleration, (ii) temperature, (iii) magnitude of electromagnetic radiation, iv) frequency of electromagnetic radiation, v) strain, vi) acceleration, vii) vibration, viii) flow rate, and (ix) pressure.

15. The apparatus of claim 9, wherein the at least one photodiode is configured to be responsive to electromagnetic radiation having a wavelength shorter than about 1350 nanometers.

16. The apparatus of claim 9, further comprising:
a carrier configured to be conveyed in a borehole, wherein the at least one photodiode is disposed on the carrier.
